(19) United States
(12) Patent Application Publication
(10) Pub. No.: US 2020/0235621 A1
(43) Pub. Date: Jul. 23, 2020

(54) STATOR ASSEMBLY WITH BOTH COPPER CONDUCTORS AND ALUMINUM CONDUCTORS DISPOSED IN SAME SLOT FOR PHASE WINDING

(71) Applicant: BorgWarner Inc., Auburn Hills, MI (US)

(72) Inventor: Tausif Husain, Carmel, IN (US)

(21) Appl. No.: 16/250,395

(22) Filed: Jan. 17, 2019

(51) Int. Cl. H02K 3/12; H02K 1/16; H02K 3/02; H02K 3/48

(52) U.S. Cl. CPC H02K 3/12; H02K 3/48; H02K 3/02; H02K 1/16

(57) ABSTRACT

A stator assembly for a multi-phase rotary electric machine includes a stator core and a stator winding routed through a plurality of circumferentially-spaced slots in the stator core. The slots each have a slot access that opens radially towards a central axis of the stator core. The stator winding includes first conductors formed of copper and second conductors formed of aluminum. The slots each include at least one of the first conductors and at least one of the second conductors with the at least one second conductor arranged radially closer to the slot access than the at least one first conductor. The second conductors near the slot access and the first conductors throughout the rest of the slot improve overall machine efficiency compared to using the first conductors alone. The improvement in efficiency using both the first and second conductors in each slot is particularly significant at high speeds.

### FIELD

This application relates to the field of electric machines, and particularly to polyphase rotary electric machines with conductor arrangements that include conductors of different materials.

### BACKGROUND

Rotary electric machines operate by exploiting the interaction of the magnetic fields of a rotor and a stator rotating relative to one another. In a common application, the rotor is disposed within and rotatable relative to the stator. The rotor is typically fixed to a shaft mounted for rotation centrally by bearings disposed in a casing that surrounds the stator. These machines include a configuration of insulated wire coils or windings in the stator, which are distributed about the stator central axis. The windings are typically arranged in a progressive sequence to define different electrical phases. The stator windings are typically wound around ferromagnetic poles of the stator core to enhance the strength of the stator's magnetic field. The stator poles generally are tooth-like cross sections that are usually rectangular or trapezoidal, and typically defined by slots in the stator core.

In a polyphase electric motor, flowing current of different phases through a progressive sequence of wire windings in the stator generates rotating magnetic fields in the stator, which impart electromechanical torque to the rotor and its shaft. Conversely, in a polyphase electric generator or alternator, externally forced rotation of the shaft and rotor imparts rotation to magnetic fields that induce current flows in the stator windings.

The stator core may be formed by a stack of interlocked, ferrous laminae, which are typically formed from electrical sheet steel. Each lamina has a central hole with the holes of all the laminae being aligned in the lamina stack to form a stator core central bore having a central axis. Thus, the stator core may be a unitary annular member with its central bore defining a radial internal bore face that is generally cylindrical and centered about the central axis. The radial internal bore face is provided with the generally axially extending, elongate slots formed by aligned, notched portions of the lamina holes that define the stator poles. The stator slots pass axially through the lamina stack adjacent the central bore since they extend over the entire axial length of the lamina stack and are open radially on an internal side and the two opposite axial ends.

The slots formed by the lamina stack typically lie in planes that intersect along and contain the stator central axis, but the slots can also be inclined with respect to central axis. The stator slots are typically distributed at an even pitch about the stator central axis. Relative to the stator, radial and axial directions mentioned herein are respective to the stator central axis, and the stator slots generally extend radially from the central bore face into the stator core and axially along the bore length. Thus, each stator core slot has a generally axial length dimension extending along the length of the stator core bore, a width dimension extending circumferentially about the central axis between a pair of adjacent stator core teeth, and a radial depth dimension extending between the slot opening proximate the stator core central bore and the slot bottom.

Elongate electrical conductors that define the stator coil windings are disposed in and extend along the stator slots. By virtue of the conductors being routed through the stator slots, they are wrapped about the stator poles. Typically, a stator slot insulator insert is located between the conductors and the walls of the stator slots to ensure electrical isolation of the stator windings from the stator core. Typically, the insulator insert is formed of a flexible, electrically insulative sheet material such as a paper or plastic that is inserted into the slot before a conductor is installed therein. The sheet material forms an electrically insulative layer between the conductors and their respective stator slot.

In a polyphase rotary electric machine, the stator coil windings include a plurality (typically three, five, six, or seven) of different phase windings each formed of elongate electrical conductor material such as a copper magnet wire or bar. The conductor cross-section is typically circular or rectangular (including square), or oval. Round wire of conventional sizes may be used for the conductors. Optionally, thick bar conductors can be used for making a wire coil with a designed current-carrying capacity requiring fewer turns than is possible with smaller sized round wire.

Each stator slot may accommodate multiple, small diameter wire segments that are wound in bulk and rather randomly oriented and located, and typically cross over each other, within the slot. Examples of such windings are well-known to those having ordinary skill in the relevant art. Alternatively, the stator slots may have a depth and/or width that is a multiple of the cross-sectional dimension of the conductor, in the slot's radial and/or circumferential direction. In the example of a three-phase stator, multiple electrical conductor segments may be housed within each of the stator slots with the electrical conductors arranged in a predetermined winding pattern to form the stator winding.

The particular winding patterns of stator windings can vary considerably between different machine designs and include, for example, standard-wind configurations, S-wind configurations, or segmented conductor configurations. S-wind configurations typically include a continuous length of wire that is wound in and out of the various slots of the stator, where end loops connect an in-slot portion in one layer to an in-slot portion in the same layer, to form a complete winding. The wire includes relatively straight lengths that are positioned within the slots of the core portion and curved lengths that extend between in-slot portions at the ends of the core portion. Similarly, in a segmented winding configuration, the windings typically comprise a plurality of segmented conductors which include in-slot portions and ends that are connected together. The in-slot portions of the conductors are positioned in the stator slots, and the ends of the conductors are connected to form windings for the electric machine.

It is known that operation of a polyphase rotary electric machine will result in inefficiencies or losses. These losses can be grouped generally as (i) resistive losses in the stator circuit, (ii) resistive losses in the rotor circuit, (iii) iron losses due to the alternating magnetic flux flow through the stator core, (iv) mechanical losses such as from friction and windage, and (v) other “stray losses” that contribute to the total loss of the electric machine. The resistive losses in the stator circuit are sometimes referred to as “copper losses,” “winding losses,” “I squared R losses,” and/or “I²R losses,” and will hereinafter be referred to as “stator winding losses.” The stator winding losses typically constitute the majority of an electric machine's losses and in some applications can represent up to 45% of the electric machine's total losses.

Stator winding losses are exacerbated in stator circuits with high-frequency alternating current (AC) due in part to the proximity effect. The term proximity effect refers to an interaction in which the alternating magnetic field associated with the alternating current induces eddy currents in adjacent conductors of the stator circuit, thereby altering the overall distribution of current flowing through these conductors. This interaction results in the current being concentrated in the areas of the conductor farthest away from nearby conductors carrying current in the same direction. The proximity effect can significantly increase the AC resistance of adjacent conductors when compared to its resistance to a DC current.

Accordingly, it would be advantageous to provide a stator assembly for a polyphase rotary electric machine with a conductor arrangement that allows winding and balancing of the electric machine to be easier, that reduces the cost of the electric machine, that make the electric machine lighter, and that gives the electric machine better high-speed efficiency.

### SUMMARY

A stator assembly for an electric machine in one embodiment includes a stator core having a plurality of teeth spaced circumferentially about a central axis of the stator core, adjacent teeth of the plurality of teeth defining respective slots in the stator core with each slot having a slot access that opens radially towards the central axis, and a stator winding routed through the slots of the stator core, the stator winding including a plurality of first conductors formed of copper and a plurality of second conductors formed of aluminum, each slot includes at least one first conductor of the plurality of first conductors and at least one second conductor of the plurality of second conductors, the at least one second conductor arranged radially closer to the slot access than the at least one first conductor.

A stator assembly for a polyphase rotary electric machine in one embodiment includes a stator core defining a plurality of circumferentially-spaced slots disposed about an axis of the stator core, the slots each having a radial ingress into the slot from a central bore of the stator, and a stator winding routed through the slots of the stator core, the stator winding including a plurality of first conductors formed of copper and a plurality of second conductors formed of aluminum, each slot includes at least one first conductor of the plurality of first conductors and at least one second conductor of the plurality of second conductors, the first and second conductors arranged in single file within each slot with the at least one second conductor blocking the radial ingress.

A polyphase rotary electric machine in one embodiment includes a rotor configured to be rotatably driven about an axis, a stator core encircling the rotor and having a plurality of teeth spaced circumferentially about and extending radially towards the axis, adjacent teeth of the plurality of teeth defining respective slots in the stator core with each slot having a slot access that radially opens the slots to a central bore of the stator core into which the rotor is disposed, and a stator winding routed through the slots of the stator core, the stator winding including a plurality of first conductors formed of copper and a plurality of second conductors formed of aluminum, each slot includes exactly two first conductors of the plurality of first conductors and exactly two second conductors of the plurality of second conductors, the two first conductors and the two second conductors arranged in single file within each slot with the two second conductors arranged radially closer to the slot access than the two first conductors.

### BRIEF DESCRIPTION OF THE DRAWINGS

FIG. 1 shows a perspective view of a stator core of a typical electric machine;

FIG. 2 shows an enlarged, cross-sectional view of a portion of the core of FIG. 1 with at least one slot of the core including a plurality of rectangular conductors formed of copper;

FIGS. 3 and 4 depict respective tables with parameters for a simulation to evaluate stator winding losses in electric machines with different numbers of conductors per slot;

FIG. 5a shows a visualization of efficiency plotted on a shaft torque versus speed graph and displays AC Loss Model data from the simulation for a stator assembly with a stator core that has four copper conductors per slot;

FIG. 5b shows a visualization of efficiency plotted on a shaft torque versus speed graph and displays AC Loss Model data from the simulation for a stator assembly with a stator core that has eight copper conductors per slot;

FIG. 5c shows a visualization of efficiency plotted on a shaft torque versus speed graph and displays AC Loss Model data from the simulation for a stator assembly with a stator core that has four conductors per slot with the two radially outermost conductors formed from copper and the two radially innermost conductors formed from aluminum in accordance with the present invention;

FIG. 6 shows an enlarged, cross-sectional view of a portion of a core in accordance with the present invention with each slot of the core including copper conductors and aluminum conductors, the aluminum conductors in each slot disposed closer to a radial ingress into the slot than the copper conductors in each slot;

FIG. 7 is a graph that illustrates the change in resistance for each of the stator cores simulated in FIGS. 5a-5c as frequency increases from zero to approximately 1000 Hertz; and

FIG. 8 depicts an enlarged, cross-sectional view of one slot of a stator core with an alternative embodiment of the copper conductors and the aluminum conductors in the slot.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that the disclosure includes any alterations and modifications to the illustrated embodiments and includes further applications of the principles of the disclosure as would normally occur to one skilled in the art to which this disclosure pertains.

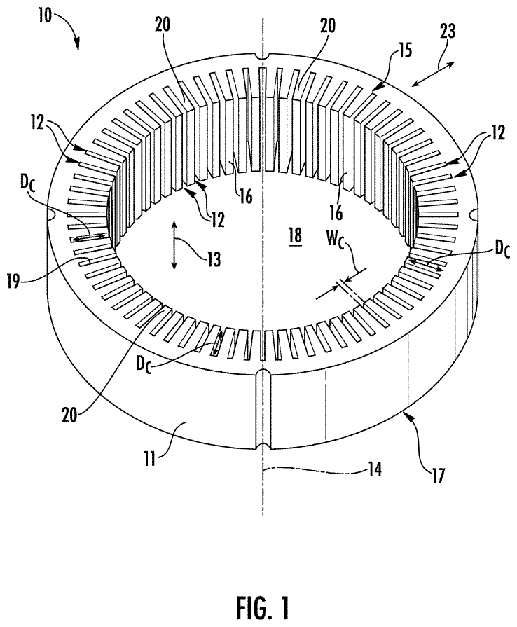

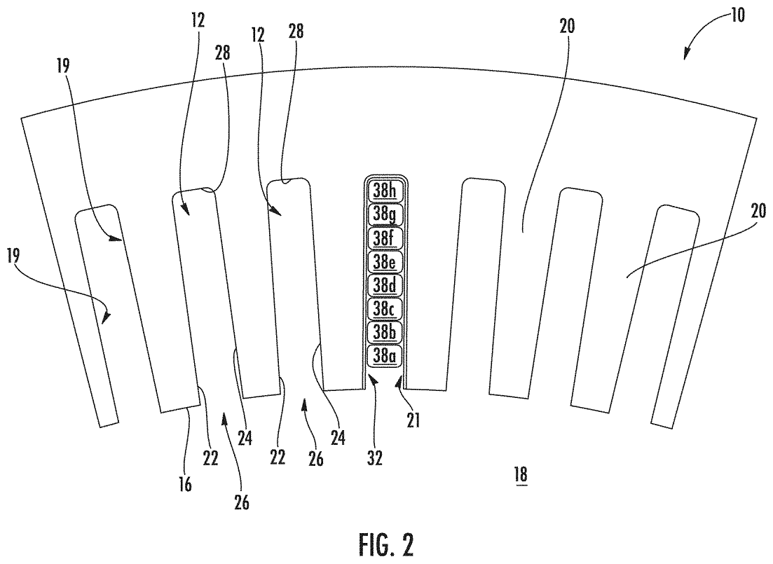

FIGS. 1 and 2 depict a typical stator core 10 for use in a three-phase rotary electric machine. The core 10 has a core body 11 that includes a number of core slots 12 arranged about a central axis 14 with each of the core slots 12 associated with one of the three current phases. This association progressively repeats itself in sequence around a circumferential inner surface 16 of the core 10, which defines a substantially cylindrical bore 18 through the core 10. The core slots 12 extend in a direction, indicated by an arrow 13, parallel to the central axis 14 of the core 10 between a first end 15 and a second end 17 thereof. As used herein, an “axially upward direction” is defined as moving toward the first end 15 of the core 10 and an “axially downward direction” is defined as moving toward the second end 17 of the core 10.

The core slots 12 are equally spaced around the circumferential inner surface 16 of the stator core 10 and respective inner surfaces 19 of the core slots 12 are substantially parallel to the central axis 14. The core slots 12 have a depth D_{C} along a radial axis, indicated by an arrow 23, and are configured to receive a stator winding, discussed in more detail below. As used herein, a “radial inward direction” is defined as moving towards the central axis 14 of the core 10 and a “radial outward direction” is defined as moving away from the central axis 14.

The core 10 is formed of a stack of aligned, interconnected electrical steel laminae, which define the circumferential inner surface 16 and the core slots 12. The following features described with reference to the “core” or “core body” also describe features of individual lamina since the stack of laminae forms the core. Similarly, figures of the present application that depict cross-sections of the “core” or “core body” can be interpreted as depicting cross-sections of individual lamina. The core slots 12 are separated from one another by stator poles or teeth 20 formed by the lamina stack. As viewed axially along arrow 13, the longitudinal inner surfaces 19 of the core slots 12 are generally U-shaped with approximately parallel sides 22, 24. The core slot sides 22, 24 extend in the radial outward direction from a slot access or radial ingress 26 in the circumferential inner surface 16. The depth D_{C} of each core slot 12 extends from the slot access 26 at the circumferential inner surface 16 to a core slot bottom 28 (FIG. 2) that is spaced in the radial outward direction from the slot access 26.

FIG. 2 shows an enlarged partial cross-sectional view of the core 10. The core slots 12 are each typically fitted with respective insulation sleeves 21 that electrically insulate the core 10 from one or more elongate segments of copper magnet wire conductors 38a-h positioned in the core slots 12. For clarity, only one of the slots 12 is shown with the insulation sleeve 21 and the wire conductors 38a-h. The wire conductors 38a-h each have a rectangular cross-sectional shape with a length extending substantially parallel to the radial axis 23 and a width extending substantially perpendicular to the radial axis 23 between the parallel sides 22, 24. The cross-sectional area of each of the rectangular conductors 38a-h is substantially equal. The rectangular conductors 38a-h are aligned in a single row by the respective parallel sides 22, 24 of the core slots 12.

The rectangular conductors 38a-h may be positioned in any configuration, including S-wind or segmented conductor configurations. Each conductor 38a-h is typically separated from neighboring conductors in the core slot 12 by at least one insulation layer (not shown) and from the core 10 by the insulation sleeve 21. The insulation layer and the insulation sleeve 21 each have a generally uniform thickness. The length and the width of each the rectangular conductors 38a-h referred to herein include the thickness of the insulation layer. The insulation sleeve 21 is positioned along the parallel sides 22, 24 and the core slot bottom 28 so as to substantially surround the conductors 38a-h in each of the slots 12 and thus defines a sleeve slot 32 with a sleeve slot width and a sleeve slot depth.

The sleeve slot width at the slot accesses 26 is slightly larger than the width of the rectangular conductors 38a-h so as to allow unrestricted radial insertion of the rectangular conductors 38a-h into each core slot 12. The stator winding may be prepared using any variation of a conventional technique suitable for rectangular wire, and the rectangular conductors 38a-h are inserted either individually or as a group into their respective core slot 12 through its opening 26. The insulation sleeve 21 is a known, flexible, dielectric material layer having thermal properties suitable for conductively transferring heat between the rectangular conductors 38a-h and the core 10. As shown, each sleeve 21 extends continually along the perimeter of its respective core slot 12 and terminates at the circumferential inner surface 16.

One issue with the core 10 depicted in FIGS. 1 and 2 is that winding a core with eight conductors is sometimes more difficult than winding cores with fewer conductors. Another issue with the core 10 depicted in FIGS. 1 and 2 is that maintaining the balance of a core with eight conductors is sometimes more difficult than maintaining the balance of cores with fewer conductors. However, simply reducing the number of conductors per slot can potentially cause other less desirable issues. One issue that can result from reducing the number of conductors per slot is an increase in stator winding losses.

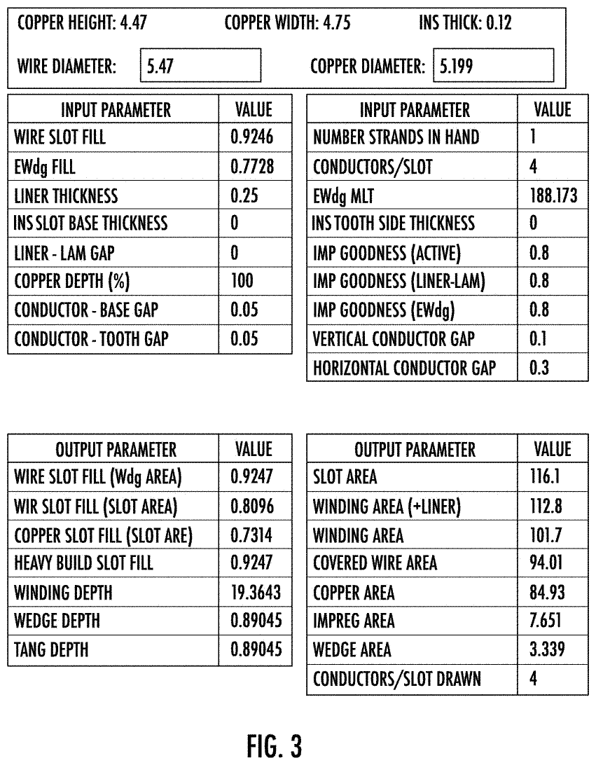

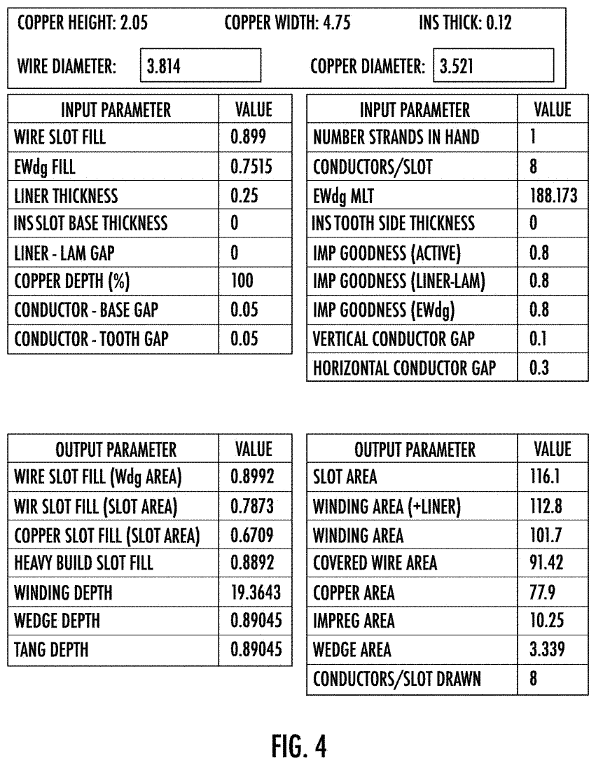

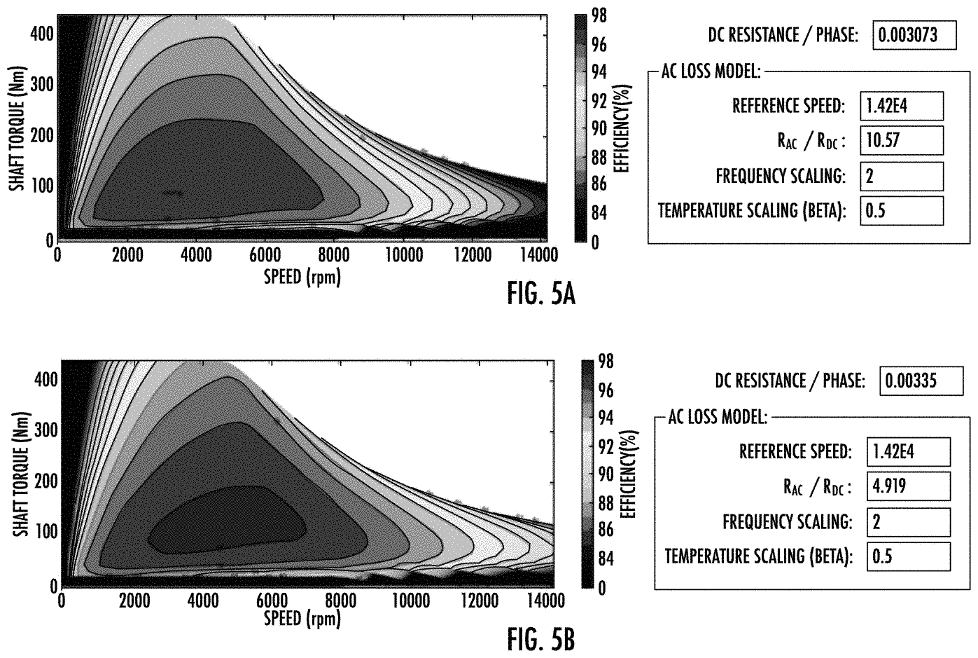

FIGS. 3 and 4 illustrate the parameters for a simulation to evaluate stator winding losses in electric machines with different numbers of conductors per slot. FIG. 3 identifies the parameters for a stator core with four copper conductors per slot (hereinafter the “4C core”) while FIG. 4 identifies the parameters for a stator core with eight copper conductors per slot (hereinafter the “8C core”). The simulation included an AC Loss Model that estimated the ratio of AC Resistance (R_{AC}) to DC Resistance (R_{DC}) for the 4C core, as shown in FIG. 5a, and for the 8C core, as shown in FIG. 5b using the following constants: Reference Speed=1.42E4, Frequency Scaling=2, and Temperature Scaling=0.5. The simulation also estimated DC Resistance per Phase for each of the 4C and 8C cores. As illustrated in FIGS. 5a and 5b, the R_{AC}/R_{DC}ratio of 10.57 for the 4C core is substantially higher than the R_{AC}/R_{DC} ratio of 4.919 for the 8C core. The increase in R_{AC}/R_{DC} ratio for the 4C core is due largely to an increase in its stator winding losses. It would be beneficial to provide a stator core assembly that addresses the issues of cores with eight conductors per slot, such as the 8C core, but that also has less stator winding losses as compared to the 4C core.

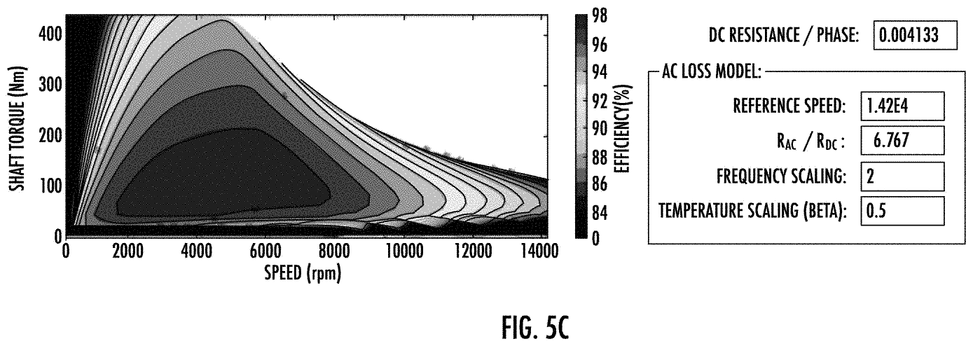

FIG. 6 shows an enlarged, partial cross-sectional view of a stator assembly 100 according to the present invention, which is configured to reduce cost, make the rotary electric machine lighter, and provide better high speed efficiency while using fewer conductors. The stator assembly 100 approximates the stator assembly simulated in FIG. 5c. The stator assembly 100 includes a stator core 110 that is configured generally in the same manner as the core 10 of FIGS. 1 and 2 except as noted herein. In FIG. 6, elements of the core 110 that are similar to elements of the core 10 of FIGS. 1 and 2 are identified with like numerals whereas new or changed elements are identified with a single prime symbol or by incrementing the prior reference number by 100.

The core 110 has a core body 111 that includes a plurality of core slots 112 arranged about the central axis 14 with each of the core slots 112 associated with one of the three current phases. This association progressively repeats itself in sequence around a circumferential inner surface 16 of the core 110, which defines a substantially cylindrical bore 18 through the core 10. The core slots 112 extend parallel to the central axis 14 of the core 110 between the first end 15 and the second end 17 thereof. The core slots 112 are equally spaced around the circumferential inner surface 16 of the stator core 110 and are substantially parallel to the central axis 14. The core slots 112 have a depth IV along the radial axis 23.

The core 110 in the illustrated embodiment is formed of a stack of aligned, interconnected electrical steel laminae, which define the circumferential inner surface 16 and the core slots 112. The core in other embodiments can be formed in any other known manner. The following features described with reference to the “core” or “core body” also describe features of individual lamina since the stack of laminae forms the core 110. The core slots 112 are separated from one another by stator poles or teeth 120 formed by the lamina stack. As viewed axially along the arrow 13 (FIG. 1), the longitudinal inner surfaces 119 of the core slots 112 are generally U-shaped with approximately parallel sides 122, 124. The core slot sides 122, 124 extend in the radial outward direction from the slot access 126 in the circumferential inner surface 16. The depth D_{C}′ of each core slot 112 extends from the slot access 126 at the circumferential inner surface 16 to a core slot bottom 128 that is spaced in the radial outward direction from the slot access 126.

The stator assembly 100 further includes a stator winding 134 routed through the slots 112 of the stator core 110. The stator winding 134 in the embodiment shown in FIG. 6 includes a plurality of first conductors 138 formed of copper and a plurality of second conductors 142 formed of aluminum. Each slot 112 includes at least one first conductor 138a of the plurality of first conductors 138a, 138b and at least one second conductor 142a of the plurality of second conductors 142a, 142b. The at least one second conductor 142a is arranged radially closer to the slot access 126 than the at least one first conductor 138a in every slot 112 of the stator core 110.

In one embodiment, as shown in FIG. 6, the first conductors in each slot 112 include exactly two first conductors 138a, 138b, and the second conductors in each slot 112 include exactly two second conductors 142a, 142b. The two first conductors in this embodiment include an outer first conductor 138b and an inner first conductor 138a disposed radially closer to the slot access 126 than the outer first conductor 138b. The two second conductors in this embodiment include an outer second conductor 142b and an inner second conductor 142a disposed radially closer to the slot access 126 than the outer second conductor 142b. The outer second conductor 142b in this embodiment is disposed radially closer to the slot access 126 than the inner first conductor 138a. In some embodiments, the inner second conductor 142a is positioned so as to effectively block the slot access or radial ingress 126. As used herein, “the inner second conductor 142a is positioned so as effectively block the slot access or radial ingress” means that the inner second conductor 142a is positioned proximate to the slot access or radial ingress 126 such that no other conductor can be positioned entirely between the inner second conductor 142a and the inner surface 16 of the stator core body 111.

In one embodiment, the first conductors 138 and second conductors 142 are connected in series. In embodiments in which the conductors have a segmented conductor configuration, portions of the first and second conductors 138, 142 are connected to form the series connection. In some of these embodiments, conductors of the same type within a slot 112 are connected in series. For example, in a stator core configured to have four conductors per slot, such as the core 110 shown in FIG. 6, the inner and outer first conductors 138a, 138b of each slot 112 are connected in series, the inner and outer second conductors 142a, 142b of each slot 112 are connected in series, and at least one of the first conductors 138 and at least one of the second conductors 142 of each slot 112 are connected in series. In some of these embodiments, conductors of the same type within a slot 112 are connected in parallel. For examples, in a stator core configured to have four conductors per slot, such as the core 110 shown in FIG. 6, the inner and outer first conductors 138a, 138b of each slot 112 are connected in parallel and the inner and outer second conductors 142a, 142b of each slot 112 are connected in parallel.

In some embodiments, the first conductors 138 in each slot 112 include one or more further first conductors (not shown) disposed between the inner first conductor 138a and the outer first conductor 138b, and the second conductors 142 in each slot 112 include one or more further second conductors (not shown) disposed between the inner first conductor 142a and the outer second conductor 142b. In these embodiments, all of the second conductors 142 are disposed radially closer to the slot access 126 than the first conductors 138. In some embodiments, each slot 112 of the stator core 110 includes the same number of each of the first conductors and the second conductors. In some embodiments, the total number of conductors in each slot 112, inclusive of both the first conductors 138 and the second conductors 142, does not exceed six.

The core slots 112 are each typically fitted with respective insulation sleeves (for clarity, not shown) that electrically insulate the core 110 from the first conductors 138 and the second conductors 142. Each conductor 138, 142 is separated from neighboring conductors in the core slot 112 by at least one insulation layer (for clarity, not shown) and from the core 110 by the insulation sleeve. The first conductors 138 and the second conductors 142 are aligned in a single row by the respective parallel sides 122, 124 of the core slots 112. In some embodiments, such as the embodiment shown in FIG. 6, a tip portion 150 of each tooth 120 is compressed radially outward such that respective portions of the parallel sides 122, 124 associated with the compressed tooth bulge circumferentially outward so as to reduce a width dimension of the slot access 126.

The first conductors 138 in the embodiment shown in FIG. 6 each have a first cross-sectional shape and a first-cross-sectional area when viewed in a section plane oriented normal to the central axis 14 and passing through the slots 112. The first cross-sectional shape is substantially the same for the inner first conductors 138a and the outer first conductors 138b in each slot 112 of the stator core 110, and the first cross-sectional area is substantially the same for the inner first conductors 138a and the outer first conductors 138b in each slot 112 of the stator core 110. The first cross-sectional shape is rectangular in the embodiment of FIG. 6 though in other embodiments the first cross-sectional shape can have other geometries. As used herein, the phrase “substantially the same” used in connection with an identified physical attribute of respective conductors means deviations of that identified physical attribute from conductor to conductor are minimized by known manufacturing methods.

The second conductors 142 in the embodiment shown in FIG. 6 each have a second cross-sectional shape and a second cross-sectional area when viewed in the section plane. The second cross-sectional shape is substantially the same for the inner second conductors 142a and the outer second conductors 142b in each slot 112 of the stator core 110, and the second cross-sectional area is substantially the same for the inner second conductors 142a and the outer second conductors 142b in each slot 112 of the stator core 110. The second cross-sectional shape is rectangular in the embodiment of FIG. 6 though in other embodiments the second cross-sectional shape can have other geometries. In the embodiment shown in FIG. 6, the first and second cross-sectional shapes of the first and second conductors, respectively, are substantially the same. Similarly, the first and second cross-sectional areas of the first and second conductors, respectively, are substantially the same in the embodiment of FIG. 6.

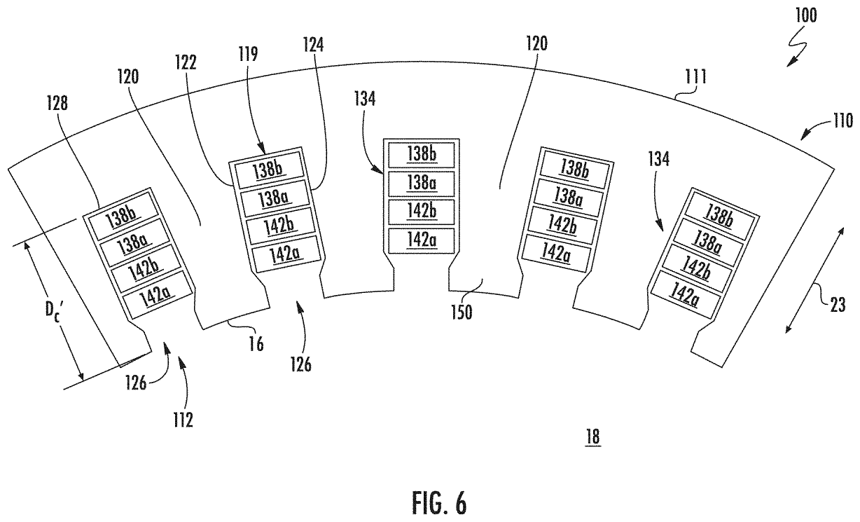

FIG. 7 graphically illustrates the change in phase resistance for each of the stator assemblies simulated in FIGS. 5a-5c as frequency increases from 0 to approximately 1000 Hertz according to the following equation:

$${R}_{ph} = {R}_{d c} [ ( \frac{{R}_{ac}}{{R}_{dc}} - 1 ) {( \frac{{ω}_{cat}}{{ω}_{ref}} )}^{ζ} + 1 ]$$

where Rₚₕ=phase resistance, R_{dc}=DC resistance, R_{ac}=AC resistance, ω_{ref}=reference speed, ω_{cal}=actual speed, and ζ=frequency scaling. As illustrated in FIG. 7, the 8C core (simulated in FIG. 5b) generally has a lower phase resistance throughout the frequency range, suggesting better overall efficiency as compared to the 4C core (simulated in FIG. 5a) and the stator assembly 100 of FIG. 6 (simulated in FIG. 5c). However, as noted above, the 8C core is harder to wind and harder to maintain balance. Additionally, due to the balance issue in the 8C core, circulating current will reduce efficiency, which is not presently modeled. The stator assembly 100 of FIG. 6 has a higher resistance at low frequencies, but a lower resistance at high frequencies when compared to the 4C core. Additionally, with reference to FIGS. 5a-5c, the stator assembly 100 has an R_{AC}/R_{DC} ratio of 6.767, which is between the R_{AC}/R_{DC} ratio of 10.57 and the R_{AC}/R_{DC} ratio of 4.919 for the 4C core and the 8C core, respectively. As such, the stator assembly 100, which includes copper conductors 138 and aluminum conductors 142 arranged in each slot 112 as described with reference to FIG. 6, can reduce cost, make the rotary electric machine lighter, and provide better high speed efficiency while using fewer conductors.

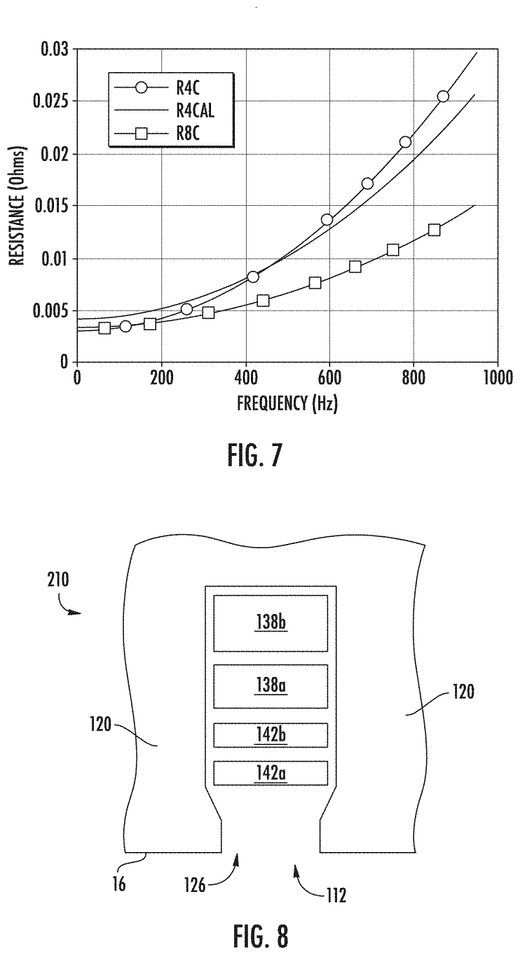

FIG. 8 depicts an enlarged, cross-sectional view of one slot 112 of a stator core 210 with an alternative embodiment of the copper conductors 138 and the aluminum conductors 142 in each slot 112. In this embodiment, the outer first conductor 138b has a first cross-sectional area when viewed in the section plane, and the inner first conductor 138a has a second cross-sectional area when viewed in the section plane. The first cross-sectional area is larger than the second cross-sectional area within each slot 112 of the stator core 210. The inner and outer second conductors 142a, 142b each have a third cross-sectional area when viewed in the section plane. The third cross-sectional area is substantially the same from second conductor to second conductor within each slot 112 of the stator core 210. The third cross-cross sectional area of the second conductors 142 is smaller than the second cross-sectional area of the inner first conductors 138a within each slot 112 of the stator core 210.

The stator cores described herein have different efficiencies at different speeds. The 8C core (simulated in FIG. 5b) has generally good efficiency across a wide speed range, but suffers from other performance issues as discussed above. The 4C core (simulated in FIG. 5a) has less desirable efficiency at speeds greater than 6000 RPM. The stator assembly 100 of FIG. 6 has adequate efficiency at speeds less than 6200 RPM, but has good efficiency at speeds greater than 6200 RPM. A stator assembly with the stator core 210 of FIG. 8 has even better efficiency in key regions than the stator assembly 100 of FIG. 6. The stator assembly 100 of FIG. 6 and the stator assembly with the stator core 210 would be beneficial for use in electric vehicles (EV) since electric machines used in EVs typically operate above 6200 RPM during operation of the EV on the highway.

The proposed invention aims to reduce AC copper losses by using a mixture of aluminum conductors and copper conductors in the same slot. Aluminum conductors are used near the slot openings where AC losses are higher. The lower conductivity of aluminum helps reduce AC losses in this key position. A combination of aluminum conductors near the slot opening and copper conductors in the rest of the slot region helps improve overall machine efficiency compared to using copper conductors all the way through the slot. The improvement to efficiency is particularly significant at high speeds. The benefit of this configuration may diminish as more conductors are used in the slot, such as greater than 6 conductors in the slot.

The foregoing detailed description of one or more embodiments of the stator assembly has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the embodiments contained herein.

What is claimed is:

1. A stator assembly for an electric machine, comprising:
a stator core having a plurality of teeth spaced circumferentially about a central axis of the stator core, adjacent teeth of the plurality of teeth defining respective slots in the stator core with each slot having a slot access that opens radially towards the central axis; and
a stator winding routed through the slots of the stator core, the stator winding including a plurality of first conductors formed of copper and a plurality of second conductors formed of aluminum,
wherein each slot includes at least one first conductor of the plurality of first conductors and at least one second conductor of the plurality of second conductors, the at least one second conductor arranged radially closer to the slot access than the at least one first conductor.

2. The stator assembly of claim 1, wherein the at least one first conductor and the at least one second conductor are arranged in single file within each slot.

3. The stator assembly of claim 1, wherein a first cross-sectional shape of the first conductors is substantially the same as a second cross-sectional shape of the second conductors when viewed in a section plane oriented normal to the central axis and passing through the slots.

4. The stator assembly of claim 3, wherein the first cross-sectional shape and the second cross-sectional shape are rectangular.

5. The stator assembly of claim 3, wherein a first cross-sectional area of the first conductors is substantially the same as a second cross-sectional area of the second conductors when viewed in the section plane.

6. The stator assembly of claim 3, wherein a first cross-sectional area of the first conductors is greater than a second cross-sectional area of the second conductors when viewed in the section plane.

7. The stator assembly of claim 1, wherein each slot includes the same number of each of the first conductors and the second conductors, and wherein a total number of the first and second conductors in each slot does not exceed six.

8. A stator assembly for a polyphase rotary electric machine, comprising:
a stator core defining a plurality of circumferentially-spaced slots disposed about an axis of the stator core, the slots each having a radial ingress into the slot from a central bore of the stator; and
a stator winding routed through the slots of the stator core, the stator winding including a plurality of first conductors formed of copper and a plurality of second conductors formed of aluminum,
wherein each slot includes at least one first conductor of the plurality of first conductors and at least one second conductor of the plurality of second conductors, the first and second conductors arranged in single file within each slot with the at least one second conductor effectively blocking the radial ingress.

9. The stator assembly of claim 8, wherein the plurality of first conductors are first segmented conductors each with a first connection end and a first bend end, wherein the plurality of second conductors are second segmented conductors each with a second connection end and a second bend end, and wherein at least one first segmented conductor is connected in series with at least one second segmented conductor at the respective first and second connection ends within each slot.

10. The stator assembly of claim 8, wherein the at least one first conductor is exactly two in number, and wherein the at least one second conductor is exactly two in number.

11. The stator assembly of claim 10, wherein the two first conductors include an outer first conductor and an inner first conductor disposed radially closer to the radial ingress than the outer first conductor, and wherein a first cross-sectional area of the outer first conductor is larger than a second cross-sectional area of the inner first conductor when viewed in a section plane oriented normal to the axis and passing through the slots.

12. The stator assembly of claim 11, wherein the two second conductors have respective third cross-sectional areas that are substantially the same when viewed in the section plane.

13. The stator assembly of claim 12, wherein the second cross-sectional area of the inner first conductor is larger than the respective third cross-sectional areas of the two second conductors when viewed in the section plane.

14. The stator assembly of claim 8, wherein none of the slots defined by the stator core are absent the at least one first conductor and the at least one second conductor.

15. A polyphase rotary electric machine, comprising:
a rotor configured to be rotatably driven about an axis;
a stator core encircling the rotor and having a plurality of teeth spaced circumferentially about and extending radially towards the axis, adjacent teeth of the plurality of teeth defining respective slots in the stator core with each slot having a slot access that radially opens the slots to a central bore of the stator core into which the rotor is disposed; and
a stator winding routed through the slots of the stator core, the stator winding including a plurality of first conductors formed of copper and a plurality of second conductors formed of aluminum,
wherein each slot includes exactly two first conductors of the plurality of first conductors and exactly two second conductors of the plurality of second conductors, the two first conductors and the two second conductors arranged in single file within each slot with the two second conductors arranged radially closer to the slot access than the two first conductors.
